(19) United States
(12) Patent Application Publication
(10) Pub. No.: US 2007/0286932 A1
(43) Pub. Date: Dec. 13, 2007

(54) Natural preservatives for preservation of perishable products

(75) Inventor: Monika Barbara Horgan, Oxford, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(73) Assignee: The Procter & Gamble Company

(21) Appl. No.: 11/810,897

(22) Filed: Jun. 7, 2007

Related U.S. Application Data
(60) Provisional application No. 60/811,867, filed on Jun. 7, 2006.

(51) Int. Cl. C11B 5/00

(52) U.S. Cl. 426/542

(57) ABSTRACT

The present invention relates to a preservative system and method for the improvement and/or stabilization of perishable food compositions. More particularly, the present invention relates to a natural preservative for improving the shelf-stability of a pet composition.

### CROSS REFERENCE TO RELATED APPLICATION

This application claims the benefit of U.S. Provisional Application No. 60/811,867, filed Jun. 8, 2006.

### FIELD OF THE INVENTION

The present invention relates to a preservative system and method for the improvement and/or stabilization of perishable food compositions. More particularly, the present invention relates to a natural preservative for improving the shelf-stability of a pet composition.

### BACKGROUND

Industrially processed food and feed products must be stored for a significant period of time in order to reach the consumer in an unspoiled state. In addition, when the consumer has purchased a food product, there is an expectation that the food will be preserved for at least a few weeks and sometimes even for months. If not treated, most food products would perish within a few days as a result of lipid oxidation, fungi and bacteria growth.

Currently, a wide variety of methods are used for preserving perishable foods. These include the addition of additives based on flavoring agents, alcohols, organic acids, aldehydes, phenolics, and essential oils. Such compositions are described in U.S. Pat. Nos. 4,446,161, 4,927,651, WO 94/14,414, GB 172993 and DE-OS 3138277. While the preservation methods described in these patents are effective, the effects on consumer health are unknown. In addition, high concentrations of preservatives are often used, which may result in allergic responses when the preserved food is ingested.

In U.S. Publication No. 2002/0176882 A1 a method for improving storage life of a food including the following composition is disclosed: a polyphenol combined with at least one alcohol that is recognized by the FDA as safe in food or benzyl alcohol combined with at least one alcohol that is recognized by the FDA as safe in food for preventing microbial deterioration of the food.

In pet foods, a blend of tocopherols, rosemary and citric acid is primarily used as a lipid oxidation preservative. However, tocopherol based antioxidants are expensive and their efficacy vary as a preservative. It is thus desirable in the pet food industry to provide an inexpensive means for preserving pet food. It is also preferable that any new means of preserving pet food provide further health benefits to a pet.

Alternative methods for preservation without using synthetic preservative include retort processing of all types of food. Typically in a retort process, food is cooked and placed in a can or container for further sterilizing and cooking. In a retort process, a retort basket is typically filled with water and containers or cans with food are placed, into the water. The water is then replaced by steam and the cans or containers are cooked at a correct pressure and temperature. While a retort process improves the preservation of a food, the techniques are complicated and consume significant energy. Also, a retort process cannot be used for thermally sensitive products.

Other methods used for preserving foods include placing a product susceptible to perishing in an air-tight package under nitrogen or CO₂ or to supply it in vacuum packages.

However, these processes are expensive and tedious, thus, for many food products including pet foods, vacuum packing cannot be used. In addition, a product is typically opened by a consumer and remains open until a food product is finished, thereby losing the benefits of vacuum packing with nitrogen or CO₂.

Accordingly, there is a need for natural preservative system that do not contain the drawbacks of the prior art. It is therefore an object of the present invention to provide natural preservatives from natural growing products that will maintain the quality and/or stability of food compositions without the addition of a synthetic preservative.

### SUMMARY OF THE INVENTION

The present invention relates to a preservative system comprising: at least one natural preservative.

The present invention further relates to a method for improving and preserving a composition comprising: obtaining a natural preservative; combining said natural preservative with a composition; improving the shelf stability of said composition.

The present invention is also directed to non-limiting methods of preparing the preservative system as described above.

### DETAILED DESCRIPTION OF THE INVENTION

The present invention is directed to a preservative system comprising: at least one natural preservative.

These and other limitations of the preservative system, compositions comprising the preservative system and methods of the present invention, as well as many of the optional ingredients suitable for use herein, are described in detail hereinafter.

As used herein, “companion animal” means a domestic animal. Preferably, “companion animal” means a dog, cat, rabbit, ferret, horse, cow, or the like. Dogs and cats are particularly preferred.

As used herein, the term “composition” means a composition that can be ingested by a companion animal, supplements for a companion animal, pet food, dog food, cat food, treats, biscuits, raw hide, treats, chews, fillers, gravy, sauce, beverage, supplemental water, and combinations thereof. The composition can be wet, moist, and/or dry.

The term “complete and nutritionally balanced” as used herein, unless otherwise specified, refers to a composition having all known required nutrients in proper amounts and proportions based upon the recommendation of recognized authorities in the field of animal nutrition.

As used herein, the term “catechins” means a group of flavonoid phytochemical compounds that appear predominately in green tea. Smaller amounts of catechins are also in black tea, grapes, and cocoa.

As used herein, the term “flavanoid” means a group of phenolic compounds with a C₆-C₃-C₆ chemical structure. Flavanoids are widely found in common edible fruits, leaves, seeds, and other parts of food plants as either glycosides or aglycones.

As used herein, the term “polyphenol” means a group of plant chemical substances, characterized by the presence of more than on phenol group per molecule. The polyphenols can be responsible for the coloring or aroma of some plants. Polyphenols are powerful antioxidants with potential health benefits including antiviral, antibacterial, anti-inflammatory, anticarcinogenic, anti-aging (neurodegenerative) effects and combinations thereof.

As used herein, the term “secondary metabolites” refer to extracts from a plant that are used for some beneficial purpose for products. Examples of the use of secondary metabolites in products include the use of extracts for food, flavors, preservatives, colors, dyes, poisons, perfumes, scented oils in aromatherapy, industrial products such as rubber and oils.

All percentages, parts and ratios as used herein are by weight of the total composition, unless otherwise specified. All such weights as they pertain to listed ingredients are based on the active level and, therefore do not include solvents or by-products that may be included in commercially available materials, unless otherwise specified.

The composition and methods of the present invention can comprise, consist of, or consist essentially of, the essential elements and limitations of the invention described herein, as well as any additional or optional ingredients, components, or limitations described herein or otherwise useful in compositions intended for companion animal consumption.

Referenced herein are trade names for components including various ingredients utilized in the present invention. The inventors herein do not intend to be limited by materials under a certain trade name. Equivalent materials (e.g., those obtained from a different source under a different name or reference number) to those referenced by trade name may be substituted and utilized in the descriptions herein.

### Preservative System

The present invention relates to a preservative system that is used for improving and preserving compositions, preferably food compositions. The preservative system of the current invention comprises natural preservatives that can also provide health benefits to a companion animal consuming the food composition comprising the natural preservatives. The preservative system comprises natural preservatives comprising secondary metabolites. The natural preservatives are selected from the group consisting of green tea, oolong tea, black tea, annatto seed, bixin, grape seed, grape seed extract, rosemary extract, sage extract, oregano extract, cocoa, fruit and vegetable extracts, and mixtures thereof.

The preservative system of the present invention can be used in a moist composition (i.e. those having a total moisture content of from about 16% to 50%, by weight of the product), and/or a wet composition (i.e. those having a total moisture content of greater than 50%, by weight of the product), and/or dry composition (i.e. those having a total moisture content of from about 0% to about 16%, by weight of the product). Unless otherwise described herein, wet composition, moist composition and/or dry composition are not limited by their composition or method of preparation.

The composition herein can be complete and nutritionally balanced. A complete and nutritionally balanced animal food composition may be compounded to be fed as the sole ration and is capable of maintaining the life and/or promote reproduction without any additional substance being consumed, except for water.

The composition and components of the present invention are selected for consumption by an animal and are not intended for consumption by humans. Non-limiting examples of compositions include supplements for an animal, pet food, dog food, cat food, treats, biscuits, raw hide, treats, chews, fillers gravy, sauce, beverage, supplemental water, and combinations thereof.

Additionally, administration in accordance with the present invention may be continuous or intermittent, depending, for example, upon the recipient's physiological condition, whether the purpose of the administration is therapeutic or prophylactic, and other factors known to skilled practitioners.

### Natural Preservatives

The preservative system of the present invention comprises natural preservatives that can comprise secondary metabolites. Nonlimiting examples of natural preservatives include the following such as: green tea, oolong tea, black tea, annatto seed, bixin, grape seed, rosemary extract, sage extract, oregano extract, cocoa, fruit and vegetable extracts, and mixtures thereof.

When a natural preservative is present in a composition, the composition comprises at least about 0.01% of a natural preservative on a dry matter basis, by weight of the composition. The composition comprises on a dry matter basis from about 0.1% of said natural preservative to about 35% of said natural preservative, from about 1% of said natural preservative to about 15% of said natural preservative, from about 1% of said natural preservative to about 10% of said natural preservative, from about 3% of said natural preservative to about 8% of said natural preservative by weight of the composition.

### Tea

Green tea, black tea, oolong tea, and white tea each have similar chemical constituents that are considered to be actively involved in the preservative effects of preservative system of the present invention.

All tea is made from the drying of the Camellia Sinensus plant leaves. The leaves of the Camellia Sinensis plant contain an enzyme called polyphenol oxidase that starts to oxidize polyphenols in the plant leaves when the leaves are plucked.

### Green Tea

The first manufacturing process for green tea of steaming or drying is known to inactivate the polyphenol oxidase. The green tea product thus contains a substantial quantity of the original leaf polyphenols, secondary metabolite, many of which are synthesized into catechins. These polyphenols primarily found in green tea are considered potent antioxidants. There are four types of polyphenols in green tea, (−) epigallocatechin gallate, (−) epichatechin gallate, (−) epigallocatechin, and (−) epicatechin. The most abundant polyphenol in green tea is (−) epigallocatechin gallate, followed by (−) epigallocatechin, then epicatechin gallate and finally epicatechin.

The green tea polyphenols, more particularly (−) epigallocatechin gallate, has been found to contribute to the stability of fats when added to compositions, thereby improving the shelf life stability of a composition.

When green tea is present, the composition comprises on a dry matter basis from about 0.01% of said green tea to about 90% of said green tea, by weight of the composition. The composition comprising on a dry matter basis from about 0.1% of said green tea to about 35% of said green tea, from about 1% of said green tea to about 15% of said green tea, from about 1% of said green tea to about 10% of said green tea, from about 3% of said green tea to about 8% of said green tea, by weight of the composition.

### Black Tea

Black tea contains smaller amounts of the four types of polyphenols found in green tea due to fermentation process. The manufacturing process for black tea consists of five main processes: withering, rolling, fermentation, firing and sorting. This five step process results in the oxidation of many of the polyphenols in the Camellia Sinensus leaf, forming other types of flavanoid compounds. These compounds include the flavanoid theaflavins and thearubigens. Theaflavins, thearubigens, polyphenols and catechins in black tea have been found to increase the shelf life stability of compositions by delaying the degradation of fat in the compositions.

When black tea is present, the composition comprises on a dry matter basis from about 0.01% of said black tea to about 90% of said black tea, by weight of the composition. The composition comprising on a dry matter basis from about 0.1% of said black tea to about 35% of said black tea, from about 1% of said black tea to about 15% of said black tea, from about 1% of said black tea to about 10% of said black tea, from about 3% of said black tea to about 8% of said black tea, by weight of the composition.

The addition of black tea also adds.increased health benefits to a companion animal ingesting the composition, including improved cardiologic activity.

### Oollong Tea

Oolong tea is manufactured in a process similar to that of black tea. When oolong tea is present, the composition comprises on a dry matter basis from about 0.01% of said oolong tea to about 90% of said oolong tea, by weight of the composition. The composition comprising on a dry matter basis from about 0.1% of said oolong tea to about 35% of said oolong tea, from about 1% of said oolong tea to about 15% of said oolong tea, from about 1% of said oolong tea to about 10% of said oolong tea, from about 3% of said oolong tea to about 8% of said oolong tea, by weight of the composition.

### Grape Seed

Grape seed is a natural plant that is rich in polyphenols. Generally, the polyphenols in grape seed are not synthesized into catechin compounds such as epigallocatechin gallate. The polyphenols contained in grape seed are considered to be powerful antioxidants. Grape seed has demonstrated the ability to stop the degradation of fat in stored compositions.

When grape seed is present, the composition comprises on a dry matter basis from about 0.01% of said grape seed to about 90% of said grape seed, by weight of the composition. The composition comprising on a dry matter basis from about 0.1% of said grape seed to about 35% of said grape seed, from about 1% of said grape seed to about 15% of said grape seed, from about 1% of said grape seed to about 10% of said grape seed, from about 3% of said grape seed to about 8% of said grape seed, by weight of the composition.

Additional health benefits that grape seeds provide to a companion animal ingesting the composition include antioxidant activity and promotion of healthy circulation.

### Annatto Seed and Bixin

Annatto seed and bixin which is approximately 20% of the annatto seed each contain similar chemical constituents that are considered beneficial for the preservation of compositions. More particularly, these chemical constituents are carotenoids. Carotenoids are organic pigments that are found in the chloroplasts of photosynthetic plants and in the chromoplasts of fruits, flowers and leaves. In accordance with the current invention it has been found that carotinoids help prevent the degradation of fat by oxygen species. Bixin is considered a strong antioxidant and quencher of singlet oxygen and helps to protect lipid membranes and inhibit lipid peroxidation, which results in stabilization of the composition.

When annatto seed is present, the composition comprises on a dry matter basis from about 0.01% of said annatto seed to about 90% of said annatto seed, by weight of the composition. The composition comprising on a dry matter basis from about 0.1% of said annatto seed to about 35% of said annatto seed, from about 1% of said annatto seed to about 15% of said annatto seed, from about 1% of said annatto seed to about 10% of said annatto seed, from about 3% of said annatto seed to about 8% of said annatto seed, by weight of the composition.

In addition, the annatto seed provides additional health benefits to a companion animal that ingests the composition, including antioxidant activity, prevention against cardiovascular disease, cancer, age related macular degeneration and photosensitive disorders.

When bixin is present, the composition comprises on a dry matter basis from about 0.01% of said bixin to about 90% of said Annatto seed, by weight of the composition. The composition comprising on a dry matter basis from about 0.1% of said bixin to about 35% of said bixin, from about 1% of said bixin to about 15% of said bixin, from about 1% of said bixin to about 8% of said bixin, from about 3% of said bixin to about 10% of said bixin, by weight of the composition.

### Rosemary Extract

Rosemary extract is a polyphenol. Constituents of rosemary or rosemary extract are coffeic acid and its derivatives such as rosemarinic acid. These compounds have antioxidant activity and anti-inflammatory effect. Coffeic acids prevent posterior capsule opacification by suppressing the transformation of the lens epithelial cells.

Nonlimiting sources of rosemary extract for use in the present invention are rosemary.

When rosemary extract is present, the composition comprises on a dry matter basis from about 0.01% of said rosemary extract to about 90% of said rosemary extract, by weight of the composition. The composition comprising on a dry matter basis from about 0.1% of said rosemary extract to about 35% of said rosemary extract, from about 1% of said rosemary extract to about 15% of said rosemary extract, from about 1% of said rosemary extract to about 10% of said rosemary extract, from about 3% of said rosemary extract to about 10% of said rosemary extract, by weight of the composition.

When rosemarinic acid is present, the composition comprises on a dry matter basis from about 0.01% of said rosemarinic acid to about 90% of said rosemarinic acid, by weight of the composition. The composition comprising on a dry matter basis from about 0.1% of said rosemarinic acid to about 35% of said rosemarinic acid, from about 1% of said rosemarinic acid to about 15% of said rosemarinic acid, from about 1% of said rosmarinic acid to about 10% of said rosemarinic acid, from about 3% of said rosemarinic acid to about 10% of said rosemarinic acid, by weight of the composition.

### Sage Extract

Sage extract is a polyphenol. Constituents of sage or sage extract are alpha- and beta-thujone, camphor, and cineole, as well as rosmarinic acid, tannins, and flavonoids. These compounds have antioxidant activity and anti-inflammatory effect.

Nonlimiting sources of sage extract for use in the present invention are sage.

When sage extract is present, the composition comprises on a dry matter basis from about 0.01% of said sage extract to about 90% of said sage extract, by weight of the composition. The composition comprising on a dry matter basis from about 0.1% of said sage extract to about 35% of said sage extract, from about 1% of said sage extract to about 15% of said sage extract, from about 1% of said sage extract to about 10% of said sage extract, from about 3% of said sage extract to about 10% of said sage extract, by weight of the composition.

### Oregano Extract

Oregano extract is a polyphenol. Constituents of oregano or oregano extract are phenolic acids (carvacrol and thymol) and flavonoids. These compounds have antioxidant activity and anti-inflammatory effect.

Nonlimiting sources of oregano extract for use in the present invention are oregano.

When oregano extract is present, the composition comprises on a dry matter basis from about 0.01% of said oregano extract to about 90% of said black tea, by weight of the composition. The composition comprising on a dry matter basis from about 0.1% of said oregano extract to about 35% of said oregano extract, from about 1% of said oregano extract to about 15% of said oregano extract, from about 1% of said oregano extract to about 10% of said oregano extract, from about 3% of said oregano extract to about 8% of said oregano extract, by weight of the composition.

### Cocoa

Cocoa is a flavonoid that is a polyphenol. Constituents of cocoa are procyanidins, catechins, and quercitin. These compounds have antioxidant activity and anti-inflammatory effect.

Nonlimiting sources of cocoa flavonoids for use in the present invention are cacao beans.

When cocoa is present, the composition comprises on a dry matter basis from about 0.01% of said cocoa to about 90% of said black tea, by weight of the composition. The composition comprising on a dry matter basis from about 0.1% of said cocoa to about 35% of said cocoa, from about 1% of said cocoa to about 15% of said cocoa, from about 1% of said cocoa to about 10% of said cocoa, from about 3% of said cocoa to about 8% of said cocoa, by weight of the composition.

### Fruit Extracts

Fruit extracts are polyphenols. The fruit extracts are rich in anthocyanins which display antioxidant activity by quenching singlet oxygen and therefore preventing the photo-oxidation of pigments.

Nonlimiting sources of fruit extracts for use in present invention are blueberries, strawberries, blackberries, raspberries, black currants, red currants, goosenberries, cherries, concord and other red grapes, pomegranate, and cranberries.

When fruit extracts is present, the composition comprises on a dry matter basis from about 0.01% of said fruit extracts to about 90% of said black tea, by weight of the composition. The composition comprising on a dry matter basis from about 0.1% of said fruit extracts to about 35% of said fruit extracts, from about 1% of said fruit extracts to about 15% of said fruit extracts, from about 1% of said fruit extracts to about 10% of said fruit extracts, from about 3% of said fruit extracts to about 8% of said fruit extracts, by weight of the composition.

### Vegetable Extracts

Vegetable extracts are phenols. The extracts display antioxidant activity by their ability to scavenge the active oxygen radicals, hydroxyl radicals, and superoxide.

Nonlimiting sources of vegetable extracts for use in present invention are sweet potato, mushroom, burdock, perilla leaf, leaves of purple radish, onion, carrot, purple radish, shallot, pumpkin, cabbage, tomato, artichoke, beet, avocado, garlic, celery, rhubarb, and spinach.

When vegetable extracts is present, the composition comprises on a dry matter basis from about 0.01% of said vegetable extracts to about 90% of said black tea, by weight of the composition. The composition comprising on a dry matter basis from about 0.1% of said vegetable extracts to about 35% of said vegetable extracts, from about 1% of said vegetable extracts to about 15% of said vegetable extracts, from about 1% of said vegetable extracts to about 10% of said vegetable extracts, from about 3% of said vegetable extracts to about 8% of said vegetable extracts, by weight of the composition.

### Emulsifiers

The preservative system of the present invention comprises a natural preservative that can be combined with an emulsifier. The combination of the emulsifier and the natural preservative improves the stability of fats when combined with a composition. Nonlimiting examples of emulsifier include the following: Choline Salts; Tannic Acid; Lecithin; Sodium Citrates; Sodium Phosphates; Potassium Phosphates; Calcium Phosphates; Propylene Glycol Alginate; Sorbitol; Polyethylene; Polysorbate 80; Polysorbate 60; Polysorbate 65; Ammonium Salts of Phosphatidic Acid; Sucrose Acetate Isobutyrate; Glycerol Esters of Wood Rosins; Potassium Pyrophosphate; Potassium Polymetaphosphate; Methyl Cellulose; Hydroxypropyl Cellulose; Hydroxypropyl Methylcellulose; Methyl Ethyl Cellulose; Aluminium, Calcium, Sodium, Magnesium, Potassium And Ammonium Salts Of Fatty Acids; Mono- and Di-Glycerides of Fatty Acids; Acetic and Fatty Acid Esters of Glycerol; Lactic and Fatty Acid Esters of Glycerol; Citric and Fatty Acid Esters of Glycerol; Diacetyltartaric and Fatty Acid Esters of Glycerol; Mixed Tartaric Acetic and Fatty Acid Esters of Glycerol; Sucrose Esters of Fatty Acids; Polyglycerol Esters of Fatty Acids; Polyglycerol Esters of Interesterified Ricinoleic Acid; Propylene Glycol Mono- and Di-Esters; Dioctyl Sodium Sulphosuccinate; Sodium Lactylate; Calcium Lactylate; Sorbitan Monostearate; Sorbitan Tristearate; Sodium Aluminium Phosphate; Bone Phosphate; Polydimethylsiloxane; Maltitol and Maltitol Syrup, and combinations thereof. Preferably the emulsifier is selected from the group consisting of lecithin, sunflower oil, monoglycerides, diglycerides, and mixtures thereof.

The emulsifier can be combined with natural preservatives and then added to a poultry fat or other fat medium in a composition. The combination of the natural preservative and the emulsifier into a composition increases the composition shelf stability.

When an emulsifier is present, the composition comprises on a dry matter basis from about 0.01% of said emulsifier to about 90% of said emulsifier, by weight of the composition. The composition comprising on a dry matter basis from about 0.1% of said emulsifier to about 35% of said emulsifier, from about 1% of said emulsifier to about 15% of said emulsifier, from about 1% of said emulsifier to about 10% of said emulsifier, from about 3% of said emulsifier to about 10% of said emulsifier, by weight of the composition.

A sonicator can be used to form an emulsion of a natural preservative and an emulsifier so that the emulsion can be incorporated into a fat medium that can be present in a composition. A sonicator is an instrument that can prepare an emulsion down to 1/100 of a micron homogenized immiscible liquid, accelerate enzymatic reactions, stimulate bacterial activity, disperse solids and degas liquids.

### Chelating Agent

The preservative system of the present invention comprises a natural preservative that can be combined with a chelating agent. The combination of the chelating agent and the natural preservative improves the stability of fats when combined with a composition. Nonlimiting examples of chelating agent include the following: citric acid, ascorbic acid, Vitamin B-12, chlorophyll, tannic acid, malic acid, sorbitol, gluconic acid, gluconate, and combinations thereof. The chelating agent can be combined with natural preservatives and then added to a poultry fat or other fat medium in a composition. The combination of the natural preservative and the chelating agent into a composition increases the composition shelf stability.

When a chelating material is present, the composition comprises on a dry matter basis from about 0.01% of said chelating agent to about 90% of said chelating agent, by weight of the composition. The composition comprising on a dry matter basis from about 0.1% of said chelating agent to about 35% of said chelating agent, from about 1% of said chelating agent to about 15% of said chelating agent, from about 1% of said chelating agent to about 10% of said chelating agent, from about 3% of said chelating agent to about 10% of said chelating agent, by weight of the composition.

A sonicator can be used to form an emulsion of a natural preservative and a chelating agent so that the emulsion can be incorporated into a fat medium that can be present in a composition. A sonicator is an instrument that can prepare an emulsion down to 1/100 of a micron homogenized immiscible liquid, accelerate enzymatic reactions, stimulate bacterial activity, disperse solids and degas liquids.

### Compositions

It is anticipated that the preservative system described in the present invention can be added to any composition adapted for administration to an animal.

Typical formulae for compositions are well known in the art. In addition to proteinaceous and farinaceous materials, the compositions of the invention generally may include vitamins, minerals, and other additives such as flavorings, preservatives, emulsifiers and humectants. The nutritional balance, including the relative proportions of vitamins, minerals, protein, fat and carbohydrate, is determined according to dietary standards known in the veterinary and nutritional art.

Nonlimiting examples of dry compositions may optionally contain on a dry matter basis, from about 1% to about 50% crude protein, from about 0.5% to about 25% crude fat, from about 1% to about 10% supplemental fiber, and from about 1% to about 30% moisture, all by weight of the composition. Alternatively, a dry composition may contain on a dry matter basis, from about 5% to about 35% crude protein, from about 5% to about 25% crude fat, from about 2% to about 8% supplemental fiber, and from about 2% to about 20% moisture, all by weight of the composition. Alternatively, the dry composition contains on a dry matter basis, a minimum protein level of about from about 9.5% to about 22%, a minimum fat level of from about 8% to about 13%, a minimum moisture level of from about 3% to about 8%, a minimum supplemental fiber level of from about 3% to about 7%, all by weight of the composition. The dry composition may also have a minimum metabolizable energy level of about 3.5 Kcal/g.

Nonlimiting examples of a moist composition may optionally contain on a dry matter basis, from about 0.5% to about 50% crude protein, from about 0.5% to about 25% crude fat, from about 0.5% to about 15% supplemental fiber, from about 30% to about 50% moisture, all by weight of the composition. Alternatively, the moist compositions may contain on a dry matter basis, from about 5% to about 35% crude protein, from about 5% to about 25% crude fat, from about 1% to about 5% supplemental fiber, and from about 35% to about 45% moisture, all by weight of the composition. Alternatively, the moist composition may have on a dry mater basis, a minimum protein level of about from about 9.5% to about 22%, a minimum fat level of from about 8% to about 13%, a minimum moisture level of about 38% to about 42%, a minimum supplemental fiber level of from about 2% to about 3%, all by weight of the composition. The moist composition may also have a minimum metabolizable energy level of about 3.5 Kcal/g and from about 0.1% to about 20% ash.

Nonlimiting examples of a wet composition may optionally contain on a dry matter basis, from about 0.5% to about 50% crude protein, from about 0.5% to about 25% crude fat, from about 0.01% to about 15% supplemental fiber, from about 50% to about 90% moisture, all by weight of the composition. Alternatively, the wet compositions may contain on a dry matter basis, from about 5% to about 35% crude protein, from about 5% to about 25% crude fat, from about 0.05% to about 5% supplemental fiber, and from about 60% to about 85% moisture, all by weight of the composition. Alternatively, a wet composition may contain on a dry matter basis, a minimum protein level of about from about 9.5% to about 22%, a minimum fat level of from about 8% to about 13%, a moisture level of from about 65% to about 80%, a minimum supplemental fiber level of from about 0.1% to about 3%, all by weight of the composition. The wet composition may also have a minimum metabolizable energy level of about 1.0 Kcal/g and from about 0.1% to about 20% ash.

In one embodiment of the present invention, the composition is an composition, whether dry, moist, wet, or otherwise, that comprises on a dry matter basis, from about 5% to about 50%, alternatively 20% to about 50% of animal-derived ingredients, by weight of the composition. Non-limiting examples of animal-derived ingredients include chicken, beef, pork, lamb, turkey (or other animal) protein or fat, egg, fishmeal, and the like.

Where the composition is in the form of a gravy, the composition may comprise at least 10% of a broth, or stock, non-limiting examples of which include vegetable beef, chicken or ham stock. Typical gravy compositions may comprise on a dry matter basis, from about 0.5% to about 5% crude protein, and from about 2% to about 5% crude fat.

Where the composition is in the form of a supplement composition such as biscuits, chews, and other treats, the supplement may comprise, on a dry matter basis, from about 20% to about 60% protein, from about 22% to about 40% protein, by weight of the supplement composition. As another example, the supplement compositions may comprise, on a dry matter basis, from about 5% to about 35% fat, or from about 10% to about 30% fat, by weight of the supplement composition.

### Optional Ingredients

The composition of the present invention can further comprise a wide range of other optional ingredients.

Nonlimiting examples of additional components include animal protein, plant protein, farinaceous matter, vegetables, fruit, egg-based materials, undenatured proteins, food grade polymeric adhesives, gels, polyols, starches, gums, flavorants, seasonings, salts, colorants, time-release compounds, minerals, vitamins, antioxidants, prebiotics, probiotics, aroma modifiers, textured wheat protein, textured soy protein, textured lupin protein, textured vegetable protein, breading, comminuted meat, flour, comminuted pasta, water, and combinations thereof.

Nonlimiting examples of optional ingredients can include at least one vegetable. Nonlimiting examples of vegetables include carrots, peas, potatoes, cabbage, celery, beans, corn, tomatoes, broccoli, cauliflower, leeks and combinations thereof.

Also useful herein, as an optional ingredient, is a filler. The filler can be a solid, a liquid or packed air. The filler can be reversible (for example thermo-reversible including gelatin) and/or irreversible (for example thermo-irreversible including egg white). Nonlirmiting examples of the filler include gravy, gel, jelly, aspic, sauce, water, air (for example including nitrogen, carbon dioxide, and atmospheric air), broth, and combinations thereof.

Nonlimiting examples of colorants include, but are not limited to, synthetic or natural colorants, and any combination thereof. When present the colorants are from about 0.0001% to about 5%, more from about 0.001% to about 1%, even more from about 0.005% to about 0.1%, on a dry matter basis, of said colorant.

Additionally, probiotic microorganisms, such as Lactobacillus or Bifidobacterium species, for example, may be added to the composition or the animal food compositions themselves.

Also useful herein, as an optional ingredient, is at least one fruit. Nonlimiting examples include tomatoes, apples, avocado, pears, peaches, cherries, apricots, plums, grapes, oranges, grapefruit, lemons, limes, cranberries, raspberries, blueberries, watermelon, cantelope, mushmellon, honeydew melon, strawberries, banana, and combinations thereof.

The composition may contain other active agents such as long chain fatty acids and zinc. Suitable long chain fatty acids include alpha-linoleic acid, gamma linolenic acid, linoleic acid, eicosapentanoic acid, and docosahexanoic acid. Fish oils are a suitable source of eicosapentanoic acids (EPA) and docosahexanoic acid (DHA). The DHA level is at least about 0.05%, alternatively at least about 0.1%, alternatively at least about 0.15% of the animal food composition, all on a dry matter basis. The EPA level is at least about 0.05%, alternatively at least about 0.1%, alternatively at least about 0.15% of the animal food composition, all on a dry matter basis.

The compositions of the present invention may further comprise a source of carbohydrate. Grains or cereals such as rice, corn, milo, sorghum, barley, wheat, and the like are illustrative sources.

The compositions may also contain other materials such as dried whey and other dairy by products.

### Method of Manufacture

The composition of the present invention may be prepared by any known or otherwise effective technique, suitable for making and formulating the desired composition. In one embodiment the composition can be prepared by mixing at least one natural preservative with an emulsifier and or chelating agent in a mixing vessel; then adding the mixture of natural preservative and emulsifier to a fat containing ingredient; and then forming the composition of the present invention.

### EXAMPLES

The following examples further describe and demonstrate embodiments within the scope of the invention. The examples are given solely for the purpose of illustration and are not to be construed as limitations of the present invention, as many variations thereof are possible without departing from the spirit and scope of the invention. All of the following examples are compositions that are utilized by a companion animal.

### Examples 1-5

To measure the stability of a composition in accordance with the current invention, an oxygen bomb is used to test the uptake of oxygen into a fat. In accordance with the current invention, the natural preservatives that perform as a preservative system result in the delay in the breakdown of fat from oxidation. According to this test, when oxidation has started to occur rapidly in the fat of a composition, the natural preservatives that have been added are considered to be no longer working. As such, in the following examples, the Oxygen Bomb test shows the number of hours that passed before oxidation started to occur in a poultry fat that has been treated with the following natural preservatives: annatto seed, green tea, white tea emulsified with lecithin, black tea emulsified with lecithin, and oolong tea emulsified with lecithin. A delay in oxidation of fat and degradation of a composition is apparent when compared to the control test where no natural preservatives were combined with the poultry fat shown in Examples 1-5. The delay is measures as a consumption of oxygen over time and is measured by Oxygen Bomb. One (1) hour in oxygen bomb is equal to 1 month of ambient storage.

### Example 1

The degradation of a poultry fat when combined with a natural preservative annatto seed at indicated amounts is shown:

| ANNATTO SEED | OXYGEN BOMB |
|---|---|
| (ppm) | (hrs) |
| 500 | 5 |
| 1000 | 2 |
| 1500 | 11 |
| 2000 | 13 |
| 2500 | 14 |
| 3000 | 15 |
| Control | 2 |

### Example 2

The degradation of a poultry fat when combined with a natural preservative green tea at indicated amounts is shown:

| Green Tea | Oxygen Bomb |
|---|---|
| (ppm) | (hrs) |
| 500 | 5 |
| 1000 | 9 |
| 1500 | 13 |
| 2000 | 14 |
| Control | 2 |

### Example 3

The degradation of a poultry fat when combined with a natural preservative white tea at indicated amounts is shown:

| White Tea with Lecithin | Oxygen Bomb |
|---|---|
| (ppm) | (hrs) |
| 500 | 8 |
| 1000 | 16 |
| 1500 | >23 |
| 2000 | 21 |
| Control | 2 |

### Example 4

The degradation of a poultry fat when combined with a natural preservative black tea at indicated amounts is shown:

| Black Tea with Lecithin | Oxygen Bomb |
|---|---|
| (ppm) | (hrs) |
| 500 | <1 |
| 1000 | 7 |
| 1500 | 9 |
| 2000 | 10 |
| Control | 2 |

### Example 5

The degradation of a poultry fat when combined with a natural preservative oolong tea at indicated amounts is shown:

| Oolong Tea with Lecithin | Oxygen Bomb |
|---|---|
| (ppm) | (hrs) |
| 500 | 5 |
| 1000 | 7 |
| 1500 | 10 |
| 2000 | 14 |
| Control | 2 |

### Examples 6-11

Dry compositions

| | Percentage % on dry matter basis (w/w) | | | | | |
|---|---|---|---|---|---|---|
| Ingredient | Example 6 | Example 7 | Example 8 | Example 9 | Example 10 | Example 11 |
| Chicken products and | 20 | 42 | 45 | 53 | 51 | 37 |
| meals | | | | | | |
| Cereal grains | 57.8 | 30.2 | 37.7 | 25.5 | 21.8 | 20 |
| Fat | 2.6 | 5.8 | 7 | 6 | 6 | 7 |
| Egg product | 3.45 | 2 | 3 | 2 | 2 | 2 |
| Vitamins | 0.15 | 0.4 | 0.6 | 0.8 | 0.4 | 0.4 |
| Minerals | 0.15 | 0.8 | 0.4 | 0.8 | 0.8 | 0.6 |
| Fiber | 3 | 5.9 | 6 | 7.05 | 7 | 7 |
| Green Tea | 0.00 | 0.9 | 0.00 | 3.0 | 0.00 | 0.00 |
| Oolong Tea | 0.15 | 0.00 | 0.00 | 0.00 | 1.00 | 0.00 |
| White Tea | 1.0 | 0.00 | 0.3 | 0.00 | 0.00 | 0.00 |
| Black Tea | 0.00 | 4.00 | 0.00 | 0.00 | 5.00 | 10.0 |
| Annatto | 0.00 | 0.5 | 0.00 | 0.00 | 0.00 | 0.00 |
| Bixin | 0.00 | 0.5 | 0.00 | 0.00 | 0.00 | 0.00 |
| Grapeseed Extract | 1.0 | 0.00 | 0.00 | 0.00 | 2.5 | 6.00 |
| Rosemary Extract | 4.0 | 5.0 | 0.00 | 1.4 | 2.5 | 0.00 |
| Sage Extract | 0.00 | 1.0 | 0.00 | 0.00 | 0.00 | 0.00 |
| Oregano Extract | 0.00 | 1.0 | 0.00 | 0.00 | 0.00 | 0.00 |
| Fruit Extract | 2.0 | 0.00 | 0.00 | 0.00 | 0.00 | 5.00 |
| Vegetable Extract | 2.0 | 0.00 | 0.00 | 0.00 | 0.00 | 5.00 |

The dry composition of Examples 6, 7, 8, 9, 10, and 11 can be made by first milling and mixing the cereal grains with vitamins and minerals and fiber and adding to the meat products and other proteins. Than adding to the cereal and protein mix fat containing a mixture of: green tea, oolong tea, black tea, annatto seed, bixin, grape seed, rosemary extract, sage extract, oregano extract, cocoa, fruit and vegetable extracts, and mixtures thereof. Extrude the ingredients into kibbles. Dry the kibbles. Package the finished product.

### Examples 12-17

Wet compositions

| | Percentage % on dry matter basis (w/w) | | | | | |
|---|---|---|---|---|---|---|
| Ingredient | Example 12 | Example 13 | Example 14 | Example 15 | Example 16 | Example 17 |
| Chicken products and | 75.2 | 18.5 | 34 | 54 | 41 | 2 |
| meals | | | | | | |
| Cereal grains | 4 | 19.4 | 17 | 19.6 | 8.7 | 1.5 |
| Egg product | 2.5 | 2 | 3 | 2 | 2 | 3.4 |
| Vitamins | 0.08 | 0.4 | 0.6 | 0.8 | 0.4 | 0.05 |
| Minerals | 0.12 | 0.8 | 0.4 | 0.8 | 0.4 | 0.15 |
| Fiber | 3 | 6 | 4.9 | 0 | 2.5 | 0 |
| Green Tea | 2.0 | 0.00 | 0.00 | 0.00 | 2.5 | 0.00 |
| Oolong Tea | 0.00 | 2.5 | 0.00 | 0.00 | 2.0 | 0.00 |
| White Tea | 2.1 | 0.00 | 0.00 | 5.8 | 0.00 | 5.9 |
| Black Tea | 0.00 | 5.4 | 7.1 | 0.00 | 0.00 | 0.00 |
| Annatto | 0.5 | 0.00 | 0.5 | 0.00 | 0.00 | 0.00 |
| Bixin | 0.5 | 0.00 | 0.5 | 0.00 | 0.00 | 0.00 |
| Grapeseed Extract | 3.0 | 0.00 | 0.00 | 1.1 | 0.00 | 3.5 |
| Rosemary Extract | 0.00 | 5.0 | 2.0 | 5.5 | 5.5 | 3.5 |
| Sage Extract | 0.00 | 0.00 | 0.00 | 0.4 | 0.00 | 0.00 |
| Oregano Extract | 0.00 | 0.00 | 0.00 | 10.0 | 0.00 | 0.00 |
| Fruit Extract | 5.00 | 20.0 | 15.0 | 0.00 | 17.5 | 40.0 |
| Vegetable Extract | 5.00 | 20.0 | 15.0 | 0.00 | 17.5 | 40.0 |

The wet composition of Examples 12, 13, 14, 15, 16, and 17 can be made by first milling and mixing the cereal grains with vitamins and minerals and fiber and adding to the meat products and other proteins, the meat products containing a mixture of: green tea, oolong tea, black tea, annatto seed, bixin, grape seed, rosemary extract, sage extract, oregano extract, cocoa, fruit and vegetable extracts, and mixtures thereof. The mixture is packaged into cans and cooked via retort process to provide finished product. For preformed pieces (chunk in gravy) mixture is extruded, passed through a steam tunnel for preconditioning, cut to desired shape, packaged with added water and retorted to provide safe finished product.

### Examples 18-23

moist compositions

| | Percentage % on dry matter basis (w/w) | | | | | |
|---|---|---|---|---|---|---|
| Ingredient | Example 18 | Example 19 | Example 20 | Example 21 | Example 22 | Example 23 |
| Chicken products and | 15 | 30 | 49 | 58 | 22 | 2.8 |
| meals | | | | | | |
| Cereal grains | 20 | 11.8 | 25 | 10 | 24 | 3.1 |
| Fat | 2.6 | 6.8 | 5.5 | 2.9 | 6 | 2.5 |
| Egg product | 15 | 20 | 5 | 2 | 12 | 2 |
| Vitamins | 0.1 | 0.05 | 0 | 0.05 | 0.1 | 0.05 |
| Minerals | 0.1 | 0.05 | 0 | 0.05 | 0.1 | 0.05 |
| Fiber | 4.4 | 3 | 5 | 2 | 5 | 7 |
| Green Tea | 0.00 | 0.00 | 0.00 | 7.0 | 1.8 | 0.00 |
| Oolong Tea | 5.0 | 0.00 | 0.00 | 0.00 | 0.00 | 3.5 |
| White Tea | 5.0 | 10.0 | 6.0 | 0.00 | 0.00 | 0.00 |
| Black Tea | 0.00 | 0.00 | 0.00 | 0.00 | 7.0 | 10.0 |
| Annatto | 3.1 | 0.00 | 0.00 | 0.5 | 0.00 | 0.00 |
| Bixin | 0.00 | 0.00 | 0.00 | 0.5 | 0.00 | 0.00 |
| Grapeseed Extract | 0.00 | 0.3 | 0.00 | 0.00 | 2.0 | 9.0 |
| Rosemary Extract | 5.0 | 5.0 | 4.5 | 5.0 | 0.00 | 0.00 |
| Sage Extract | 7.5 | 0.00 | 0.00 | 2.0 | 0.00 | 10.0 |
| Oregano Extract | 7.5 | 0.00 | 0.00 | 2.0 | 0.00 | 10.0 |
| Fruit Extract | 5.0 | 7.0 | 0.00 | 5.0 | 10.0 | 20.0 |
| Vegetable Extract | 5.0 | 6.0 | 0.00 | 5.0 | 10.0 | 20.0 |

The moist composition of Examples 18, 19, 20, 21, 22, and 23 can be made by first milling and mixing the cereal grains with vitamins and minerals and fiber and adding to the meat products and other proteins with humactants to control water activity and mold. Than adding to the cereal and protein mix fat containing a mixture of: green tea, oolong tea, black tea, annatto seed, bixin, grape seed, rosemary extract, sage extract, oregano extract, cocoa, fruit and vegetable extracts, and mixtures thereof. Extrude the ingredients into desired shape. Package the finished product.

It should be understood that every maximum numerical limitation given throughout this specification includes every lower numerical limitation, as if such lower numerical limitations were expressly written herein. Every minimum numerical limitation given throughout this specification includes every higher numerical limitation, as if such higher numerical limitations were expressly written herein. Every numerical range given throughout this specification includes every narrower numerical range that falls within such broader numerical range, as if such narrower numerical ranges were all expressly written herein.

All parts, ratios, and percentages herein, in the Specification, Examples, and Claims, are by weight and all numerical limits are used with the normal degree of accuracy afforded by the art, unless otherwise specified. All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written documents shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A preservative system comprising: at least one natural preservative.

2. The preservative system of claim 1, wherein said natural preservative is selected from the group consisting of green tea, oolong tea, black tea, annatto seed, bixin, grape seed, grape seed extract, rosemary extract, sage extract, oregano extract, cocoa, fruit extracts, vegetable extracts, and mixtures thereof.

3. The preservative system of claim 1 wherein said preservative system further comprises an emuslifier.

4. The preservative system of claim 3, wherein said emulsifier is selected from the group consisting of lecithin, sunflower oil, monoglycerides, diglycerides, and mixtures thereof.

5. The preservative system of claim 3, wherein said emulsifier and said natural preservative are combined to form an emulsion.

6. The preservative system of claim 1 wherein said preservative system further comprises a chelating agent.

7. The preservative system of claim 6, wherein said chelating agent is selected from the group consisting of citric acid, ascorbic acid, Vitamin B-12, chlorophyll, tannic acid, malic acid, sorbitol, gluconic acid, gluconate, and mixtures thereof.

8. The preservative system of claim 1, wherein said natural preservative is present in a composition.

9. The preservative system of claim 8, wherein said composition comprises at least about 0.1% on a dry matter basis of said natural preservative, by weight of the composition.

10. The preservative system of claim 8, wherein said composition is wet, moist, or dry.

11. The preservative system of claim 8, wherein said composition is selected from the group consisting of supplements for a companion animal, pet food, dog food, cat food, treats, biscuits, raw hide, chews, fillers, gravy, sauce, beverage, supplemental water, and combinations thereof.

12. A method for improving and preserving a composition comprising:
a. obtaining a natural preservative;
b. combining said natural preservative with a composition;
c. improving the shelf stability of said composition.

13. The method of claim 12, wherein said natural preservative is selected from the group consisting of green tea, oolong tea, black tea, annatto seed, bixin, grape seed, grape seed extract, rosemary extract, sage extract, oregano extract, cocoa, fruit and vegetable extracts, and mixtures thereof.

14. The method of claim 12, further comprising (d) mixing an emulsifier with said natural preservative before combining with said composition.

15. The method of claim 12, further comprising (d) mixing an chelating agent with said natural preservative before combining with said composition.

16. The method of claim 14, wherein said emulsifier is selected from the group consisting of lecithin, sunflower oil, monoglycerides, diglycerides, and mixtures thereof.

17. The method of claim 12, wherein said composition comprises at least about 0.1% on a dry matter basis of said natural preservative, by weight of the composition.

18. The method of claim 12, wherein said composition is wet, moist, or dry.

19. The method of claim 12, wherein said composition is selected from the group consisting of supplements for a companion animal, pet food, dog food, cat food, treats, biscuits, raw hide, chews, fillers, gravy, sauce, beverage, supplemental water, and combinations thereof.
